(19) United States
(12) Patent Application Publication
(10) Pub. No.: US 2007/0131122 A1
(43) Pub. Date: Jun. 14, 2007

(54) Powered baster

(76) Inventor: Marian Cruz, Fremont, CA (US)

Correspondence Address: DERGOSITS & NOAH LLP, FOUR EMBARCADERO CENTER, SUITE 1450, SAN FRANCISCO, CA, 94111, US

(21) Appl. No.: 11/299,856

(22) Filed: Dec. 12, 2005

(51) Int. Cl. A47J 37/10

(52) U.S. Cl. 99/345

(57) ABSTRACT

A powered baster for the acceptance, containment and distribution of basting fluid. The powered baster is characterized as having a housing, a plunger for longitudinal movement within the housing and a motor for controlling movement of the plunger. The motor is controlled externally of the housing with switching means for turning the motor on and off and for controlling movement of the plunger to travel longitudinally away from and towards the motor.

### TECHNICAL FIELD

The present invention involves a baster which is powered for the acceptance, containment and distribution of basting fluids. The baster is provided with a motor for controlling withdrawal of basting fluids, their containment and ultimate distribution in a metered fashion.

### BACKGROUND OF THE INVENTION

Basting is an important part of cooking, particularly when it comes to cooking turkey, chicken and roasts. Baking such consumables tends to try them out and greatly enhanced results can be achieved if juices which leach from them can be reintroduced during the cooking process.

Up to now, basting has been a rather inexact operation and one which has not been particularly easy to perform for a number of reasons. In this regard, reference is made to FIG. 1 showing a typical prior art baster 10 composed of stem 12 and compressible bulb 11. In operation, a user would squeeze bulb 11 to exhaust air contained therein. The air would emanate through stem 12 and out opening 13 whereupon baster 10 would be dipped within appropriate cooking juices or basting fluids whereupon bulb 11 would be release causing these fluids to be drawn up through opening 13.

Use of baster 10 is not only inconvenient to use but often times does not provide its user with sought after results. Basting fluid can often times foul stem 12 and bulb 11 making cleaning quite difficult. This is complicated by the recognition that basting fluid is generally high in fat content and is often times a carrier for solid debris that falls from or otherwise separates from the turkey, chicken or roast as it is cooking. Further, it is often times desirable to inject basting fluid directly in a food product, such as within the cavity of a turkey as it is being roasted to commingle with, for example, bread-based stuffing. Pressing upon bulb 11 provides uneven and often times non-existent distribution if basting fluid and the user is not cognizant of how much of such fluid has been appropriately dispensed. Further, basting fluid is quite frequently used to make gravy by adding it to pre-measured ingredients. Applying the basting fluid directly from hand held baster 10 makes dispensing the appropriate amount of such fluid in a gravy recipe quite difficult to control.

It is thus an object of the present invention to provide a baster which overcomes the various problems as outlined above.

It is yet a further object of the present invention to provide a baster which is self-powered to enable a user, through the flip of a switch, to extract, contain and distribute a pre-determined amount of basting fluid in a manner unachievable by the prior art.

These and further objects will be more readily appreciated when considering the following disclosure and appended claims.

### SUMMARY OF THE INVENTION

The present invention deals with a power baster for acceptance, containment and distribution of basting fluids. The power baster comprises a housing, a plunger for longitudinal movement within the housing and a motor for controlling movement of the plunger. The motor is controlled externally of the housing with switching means for turning the motor on and off and for controlling movement of the plunger to travel longitudinally away from and towards the motor.

### BRIEF DESCRIPTION OF THE FIGURES

FIG. 1 is a side perspective view of a baster of the prior art.

FIG. 2 is a side partial cut away view of the baster of the present invention showing its internal components.

FIGS. 3A and 3B are examples of attachment ends to the baster of FIG. 2 alternatively showing such attachments as functional elements in practicing the present invention.

### DETAILED DESCRIPTION OF THE INVENTION

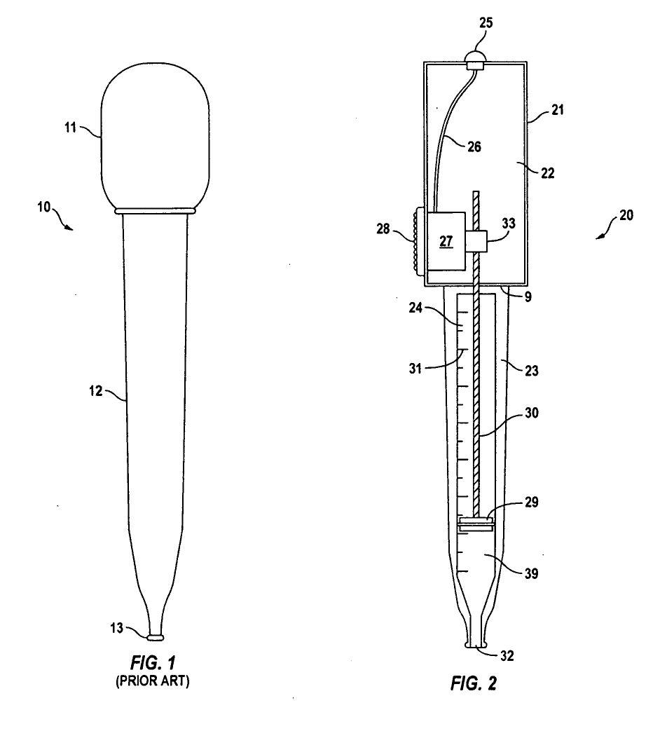

As noted previously, the present invention deals with a powered baster for the acceptance, containment and distribution of basting fluids. To more fully appreciate the present invention, reference is made to FIG. 2. Powered baster 20 is shown including its outer shell or housing 21 comprised of upper housing subpart 22 and lower housing subpart 23. Subparts 22 and 23 can be either screwed or fictionally fit to releaseably attach to one another along seam 9 to enable powered baster 20 to be disassembled to facilitate its cleaning and repair.

In further reference to FIG. 2, housing 21 supports motor 27. Motor 27 can be actuated by virtue of on/off switch 25 functionally connected to motor 27 through wires 26. In addition, motor 27 is intended to be reversible by virtue of slide switch 28. It should be noted, however, that slide switch 28 and off/on switch 25 are shown as separate control elements as a preferred embodiment in practicing the present invention. Anyone skilled in this art would recognize that these switches could be incorporated into a single externally located control element whereby, for example, a multi function switch could be employed whereby a first depression of such switch would activate motor 27 while a second depression of the switch would change its direction of operation and a third depression of this switch would turn the motor back to a previous orientation with a fourth depression of the switch turning the motor off.

Regardless of how motor 27 is controlled, it is contemplated that it be provided with a gear 33 which engages helical shaft 30 which supports plunger 29 at its distal end. Thus, depending upon the orientation of motor 27, plunger 29 can be moved longitudinally towards motor 27 or away from it in order to control the acceptance, containment and distribution of basting fluids within chamber 39.

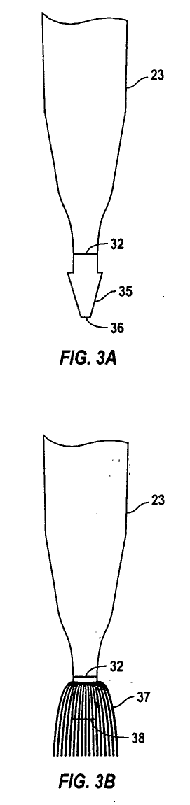

In operation, a fluid interface attachment such as shown in FIGS. 3A and 3B would be fit onto powered baster 20 at input orifice 32. The fluid interface attachment would then be submerged at least as to its own input opening such as openings 36 and 38 of the fluid attachment structures shown in FIGS. 3A and 3B, respectively. Upon doing so, plunger 29 would be drawn towards motor 27 the actuation of motor 27 causing gear 33 to appropriately turn upon the helical windings of helically extending shaft 30. The exact amount of basting fluid contained within reservoir 39 can be seen through transparent window 24 and its metered amount can be determined through the position of plunger 29 along lines of demarcation 31 which could be, for example, expressed in fluid ounces or cups.

When it is appropriate, switch 28 can be actuated to reverse motor 27 thus causing plunger 29 to extend away from motor 27 and towards opening 32 as longitudinally extending helical shaft 30 as acted upon by gear 33.

When dispensing basting fluid contained within powered baster 20, fluid interface attachments can be employed, as discussed previously. In this regard, reference is made to FIG. 3A in which such a fluid interface attachment comprises a cone-like structure having a centrally located channel which is in fluid communication with opening 36 and port 32. Such a structure is particularly advantageous for withdrawing liquid fats which drip from turkey, chicken, roasts and other meat products and injecting them back within those meat products by employing cone-like structure 35 as a penetrating tool. The present invention can also be used for distributing fluids on food products other than meats. For example, melted butter could be dispensed onto corn conveniently.

Alternatively, it is often times desirable to brush basting fluids back upon a suitable food product. In this regard, a fluid interface attachment is shown comprised of brush 37 again having a centrally located channel in fluid communication between basting fluid input port 38 and power baster input port 32.

The present invention can be employed for drawing, housing and dispensing liquids other than fat which is dripped from a meat product during baking. For example, it is often times advantageous to maintain moisture and fat content in such things as roasted turkey. Because of its size, a turkey must often times be cooked for an extended period of time to ensure that the meat internal to the turkey is fully cooked. In doing so, however, the outer surface and skin of the turkey can dry providing a less than desirable product. The present power baster 20 can be employed by dipping either fluid interface attachment means 35 or 37 into melted butter and dispensing the melted butter onto the meat surface.

Finally, in producing such things as gravy, it is common to mix basting fluid with pre-measured ingredients which are then served as an adjunct to the meat product. The present power baster, through the use of transparent window 24 and quantity demarcations 31 enables a user to dispense known measured amounts of basting fluid directly into a pre-determined recipe of ingredients.

1. A powered baster for the acceptance, containment and distribution of basting fluids, said power baster comprising a housing, a plunger for longitudinal movement within said housing and a motor for controlling movement of said plunger, said motor being controlled externally of said housing with a switching means for turning said motor on and off and for controlling movement of said plunger, said motor being controlled externally of said housing with a switching means for turning said motor on and off and for controlling movement of said plunger to travel longitudinally away from and toward said motor.

2. The powered baster of claim 1 wherein said housing comprises a fluid port of accepting and distributing basting fluids controllably through longitudinal movement of said plunger.

3. The powered baster of claim 2 further comprising a fluid interface attachment for releaseably appending to said fluid port.

4. The powered baster of claim 3 wherein said fluid interface attachment comprises a cone-like structure having a centrally-located channel and fluid communication with said fluid port.

5. The powered baster of claim 3 wherein said fluid interface attachment comprises a brush having a centrally-located channel and fluid communication with said fluid port.

6. The powered baster of claim 1 wherein at least a portion of said housing is transparent to reveal the volume of basting fluid contained therein.

7. The powered baster of claim 6 wherein said housing at least in said portion that is transparent has volume indicator inscriptions to enable a user to know the volume of baster fluid contained within said housing.

8. The powered baster of claim 1 wherein said housing comprises a top portion and a bottom portion, said top and bottom portions being detachable from one another to enable a user access to the interior of the housing for its cleaning and repair.

9. The powered baster of claim 1 wherein said plunger is fixedly attached to a helically extending shaft.

10. A method of applying a bating fluid to a food product, said method comprising providing a powered baster comprising a housing, a plunger for longitudinal movement within said housing and a motor for controlling movement of said plunger, said motor being controlled externally of said housing with or switching means for turning said motor on and off and for controlling movement of said plunger, to travel longitudinally away from and toward said motor, said method further comprising dipping said housing having a basting fluid receiving port into a supply of basting fluid once said plunger has been extended away from said motor, actuating said motor to move said plunger toward said motor to withdraw said basting fluid into said housing and reversing said motor to dispense said basting fluid to said food product.
